(19) United States
(12) Patent Application Publication
(10) Pub. No.: US 2009/0013537 A1
(43) Pub. Date: Jan. 15, 2009

(54) Folding knife

(76) Inventor: Chih-Chen Kao, Taoyuan City (TW)

Correspondence Address: BACON & THOMAS, PLLC, 625 SLATERS LANE, FOURTH FLOOR, ALEXANDRIA, VA, 22314-1176, US

(21) Appl. No.: 11/822,766

(22) Filed: Jul. 10, 2007

(51) Int. Cl. B26B 1/06

(52) U.S. Cl. 30/159; 30/160

(57) ABSTRACT

The invention discloses a folding knife having a knife handle and a blade. A pivotal shaft is at an end of the knife handle; a limit slot is inside the knife handle; and a latch element is in the limit slot. The blade is pivotally coupled to the knife handle through the pivotal shaft. The blade includes a protruding pillar corresponding to a latch portion. When the blade is stored into the knife handle, the protruding pillar is fixed between the limit slot and the latch element, and the blade will not pivot out of the knife handle due to shakes or vibrations. If a predetermined force is applied to rotate the blade towards the knife handle, the protruding pillar will rotate in conformity with the blade and push the latch element, so that the protruding pillar is released and rotated with the blade in the limit slot.

### FIELD OF THE INVENTION

The present invention relates to a folding knife, and more particularly to a folding knife that can meet the strict safety requirements while maintaining the convenience of use of the knife.

### BACKGROUND OF THE INVENTION

As science and technology advance rapidly, people have increasingly higher demand on the quality of our life, and thus research and development are conducted extensively in different fields to provide more innovative and advanced products that give more convenience to users. This trend is not limited to the area of high-tech products only, but it is also applied in the area of our daily products. With customer complaints on the inconvenience and the poor design of products, the products are improved to provide a more convenient and advanced application to users, so that manufacturers focus on the objectives of designing their products with a better quality of life and a more convenient function of the products. One of these products is a foldable switchblade, and the switchblade not only comes with the features of broad applicability and easy portability, but also provides a wide scope of applications to outdoor leisure activities, and thus the foldable switchblade becomes very popular to people who love outdoor and leisure activities.

Referring to FIG. 1, the main structure of such conventional switchblade 1 includes a hollow handle 10 and a blade 11, wherein the blade 11 is pivotally coupled to the hollow handle 10, and a slot 100 is created on a side of the hollow handle 10 for pivoting the blade 11 out of the hollow handle 10, and a pivotal connecting portion 121 is disposed at a pivotal connecting position of the blade 11 and the hollow handle 10, and the blade 11 has a latch groove 111 disposed at a portion of a knife edge 110 proximate to the pivotal connecting portion 121, and a pivotal shaft 12 is disposed at the pivotal connection position of the hollow handle 10 and the blade 11, such that the pivotal shaft 12 is pivotally connected to the pivotal connecting portion 121, and the hollow handle 10 includes a resilient member 13 connected to the blade 11 and disposed within the periphery of the pivotal shaft 12. Further, the hollow handle 10 includes a press switch 14 disposed inside the hollow handle 19 and proximate to the pivotal shaft 12 and protruded from a surface of the hollow handle 10 for latching the latch groove 111 or releasing the blade 11. If the press switch 14 is pressed, the latch of the press switch 14 with the blade 11 is released, so that the blade 11 can be pivoted out of the hollow handle 10 quickly by the resilience of the resilient member 13. In other words, a user can operate the switchblade 1 quickly and easily by a hand.

However, the press switch 14 is protruded from a prominent position on the surface of the hollow handle 10, and thus the switchblade 1 may be touched or triggered accidentally by a user or a child and the blade 11 is pivoted out of the hollow handle 10, and thus the blade 11 may cut or injure the user, and such design with good intentions may be turned out to be a risk to users. Since the resilient member 13 of the switchblade 1 comes with a powerful resilience, the powerful resilience not only can pivot the blade 11 out of the hollow handle 10 quickly, but also may cut or prick the user's body when the switchblade 1 is put into a user's pocket, and the blade 11 is pivoted out of the hollow handle 10 due to a gentle external touch or an unintentional collision. Although such conventional switchblade 1 is convenient to use, they also create a big threat to the safety of the users and fail to meet the strict safety requirements.

In summation, knife manufacturers put more effects on safety for the design of a knife, in addition to the stylish look, function and convenience of the knife. Therefore, the design of knives not only shows personal tastes, but also integrates the features of user-friendliness, multiple functions and convenience while maintaining a simple structural design and improving safety. Safety is one of the key factors to success or a gain of market shares for knife manufacturers, and thus finding a way of enhancing the product safety of a knife to meet strict safety requirements while maintaining the convenience of the knife becomes an important subject for manufacturers.

### SUMMARY OF THE INVENTION

In view of the foregoing shortcomings of the prior art, the inventor of the present invention based on years of experience in the related industry to conduct extensive researches and experiments, and finally developed a folding knife in accordance with the present invention to overcome the shortcomings of the prior art.

It is a primary objective of the present invention to provide a folding knife, comprising: a knife handle and a blade, wherein a pivotal shaft is installed at an end of the knife handle, and a limit slot is disposed inside the knife handle, and a latch element is disposed in the limit slot. The blade is pivotally coupled into the knife handle through the pivotal shaft, and the blade includes a protruding pillar disposed at a position corresponding to a latch portion. When the blade is stored into the knife handle, the protruding pillar can be fixed between the limit slot and the latch element, such that the blade will not pivot out of the knife handle due to shakes or vibrations. If a predetermined force is applied to rotate the blade towards the knife handle, the protruding pillar will rotate in conformity with the blade and push the latch element, so that the protruding pillar is released by the latch element and rotated in conformity with the blade in the limit slot. Therefore, the folding knife can extend or store its blade. When the blade is stored into the knife handle, the blade can be securely fixed to prevent the blade from pivoting out of the knife handle by vibrations, collisions or unintentional touches, so as to improve the safety of the folding knife.

To make it easier for our examiner to understand the objective, technical characteristics and effects of the present invention, preferred embodiments will be described with accompanying drawings as follows:

### BRIEF DESCRIPTION OF THE DRAWINGS

FIG. 1 is a perspective view of a conventional switchblade;

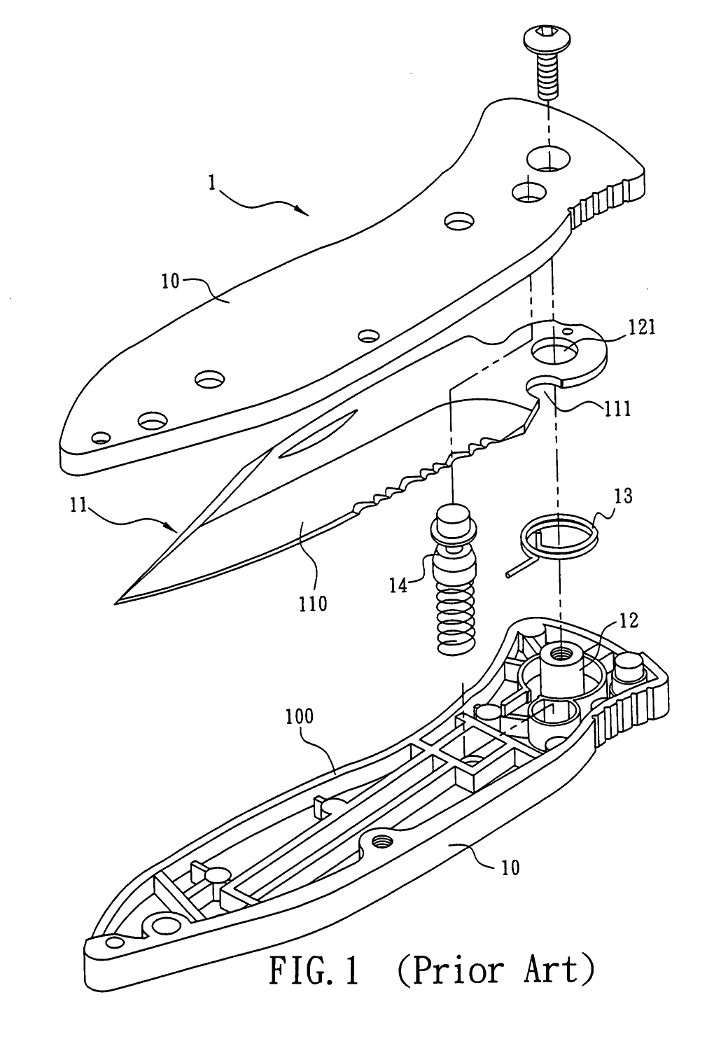

FIG. 2 is an exploded view of a folding knife in accordance with a first preferred embodiment of the present invention;

FIG. 3 is a perspective view of a folding knife in accordance with a first preferred embodiment of the present invention;

FIG. 4 is a perspective view of a status of using a folding knife in accordance with a first preferred embodiment of the present invention;

FIG. 5 is another perspective view of a status of using a folding knife in accordance with a first preferred embodiment of the present invention;

FIG. 6 is a perspective view of a folding knife in accordance with a second preferred embodiment of the present invention; and

FIG. 7 is a perspective view of a folding knife in accordance with a third preferred embodiment of the present invention.

### DETAILED DESCRIPTION OF THE PREFERRED EMBODIMENTS

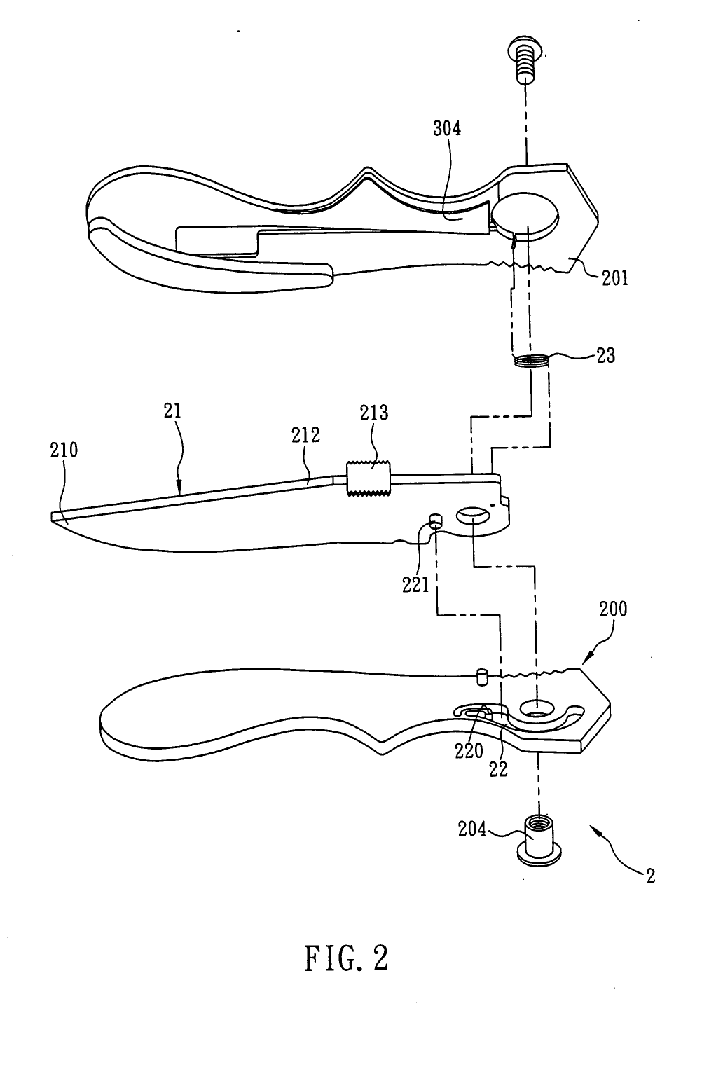

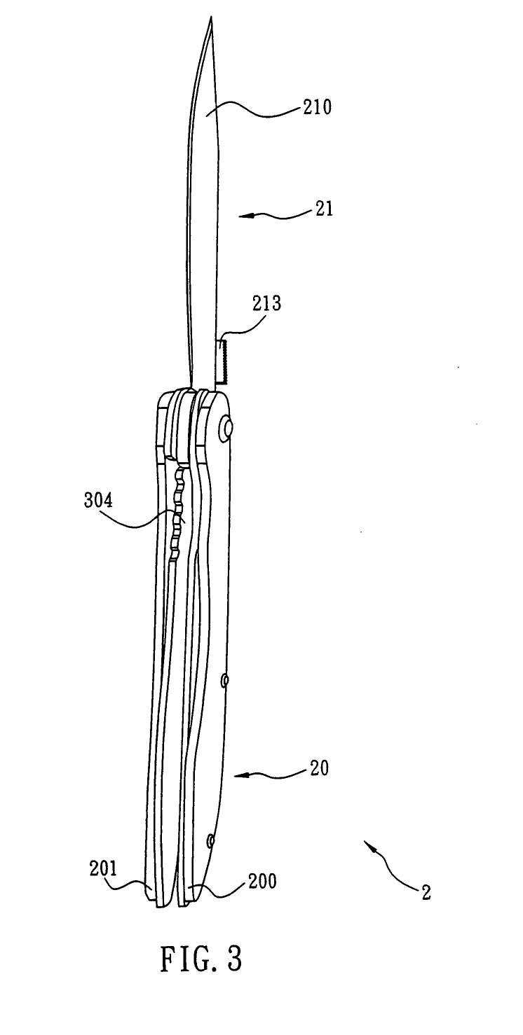

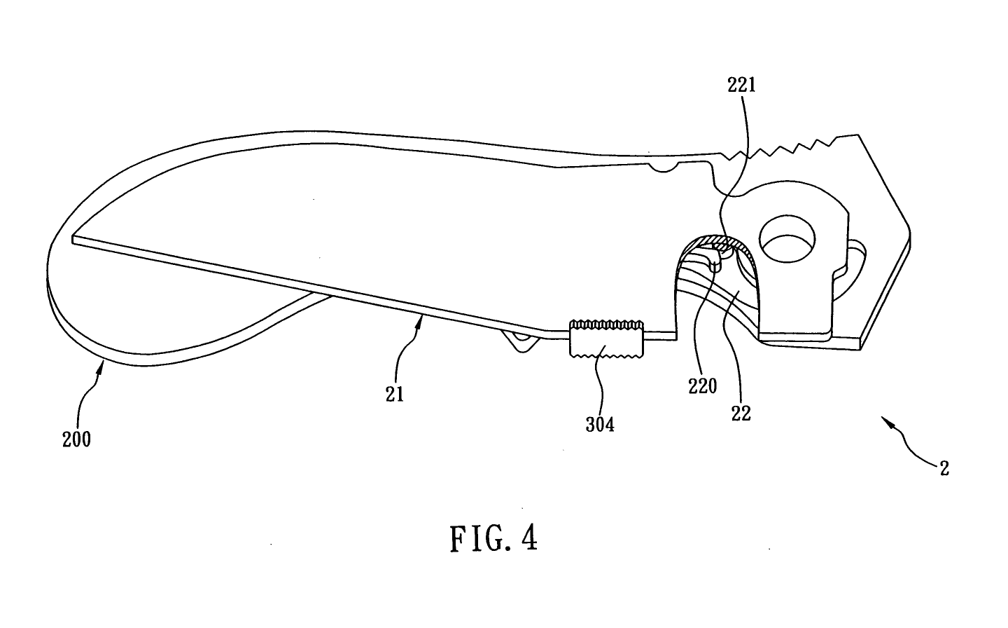

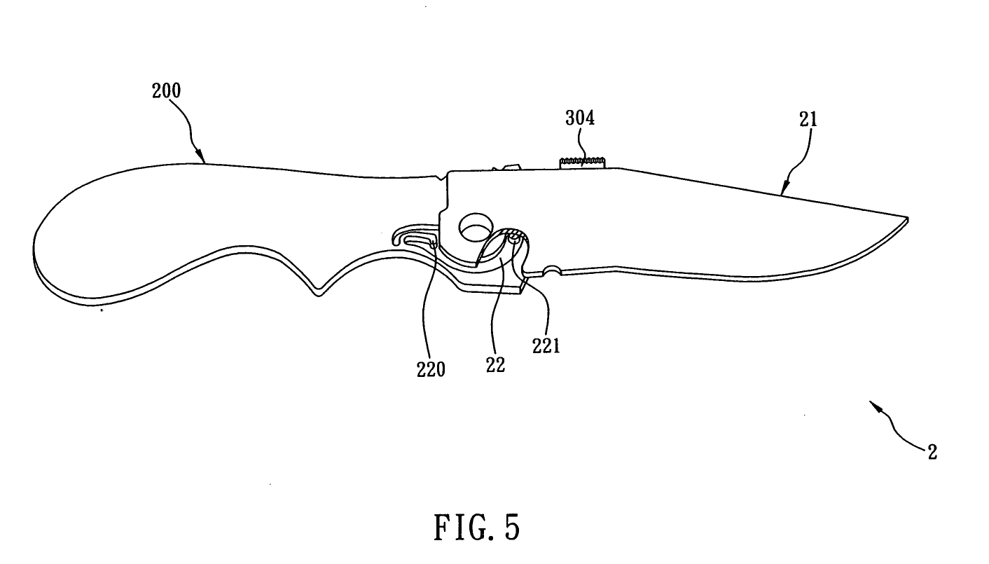

Referring to FIGS. 2 and 3 for an exploded view and a perspective view of a folding knife in accordance with a first preferred embodiment of the present invention respectively, the folding knife 2 comprises a knife handle 20 and a blade 21, wherein the knife handle 20 includes a first board having a first board 200 and a second board 201, and the boards 200 are stacked and engaged with each other, and a pivotal shaft 204 is disposed at an end of the boards 200, 201, and a limit slot 22 is disposed on the first board 200 and at a position proximate to the pivotal shaft 204, and the limit slot 22 includes a latch element 220 therein, and an end of the blade 21 away from its knife tip 210 is pivotally coupled between the first board 200 and the second board 201 through the pivotal shaft 204, and the blade 21 has a protruding pillar 221 disposed at a position corresponding to the limit slot 22. When the blade 21 is rotated towards the knife handle 20, the protruding pillar 221 rotates in conformity with the blade 21 in the limit slot 22, until the protruding pillar 221 is fixed between the limit slot 22 and the latch element 220 (as shown in FIG. 4), so that the blade 21 can be fixed and stored into the knife handle 20. If a predetermined force is applied to rotate the blade 21 out from the knife handle 20, the protruding pillar 221 also rotates in conformity with the blade 21 and pushes the latch element 220, so that the protruding pillar 221 is released by the latch element 220, and the blade 21 can be rotated out from the knife handle 20 (as shown in FIG. 5). Therefore, the folding knife 2 can extend or store its blade 21 flexibly, and when the blade 21 is stored in the knife handle 20, the blade 21 can be fixed securely and prevented from pivoting out of the knife handle 20 due to vibrations or unintentional collisions, so as to improve the safety of the folding knife 2.

In a first preferred embodiment of the present invention as shown in FIGS. 2 and 3 for, the limit slot 22 proximate to an end of the pivotal shaft 204 is designed in an arc shape for rotating the protruding pillar 221 in conformity with the blade 21 in the limit slot 22, and the blade 21 is rotated within the limit range of the limit slot 22 through the protruding pillar 221, so that the blade 21 can be extended smoothly out of the knife handle 20 at a better angle for its use, or stored smoothly into the knife handle 20. Further, another end of the limit slot 22 is provided for the latch element 220 to fix the protruding pillar 221, or provided as a space for pushing the protruding pillar 221, and thus the folding knife 2 can extend or store its blade 21 flexibly. When the blade 21 is stored into the knife handle 20, the blade 21 can be fixed securely and prevented from pivoting out of the knife handle 20 by vibrations or collisions, so as to improve the safety of the folding knife 2.

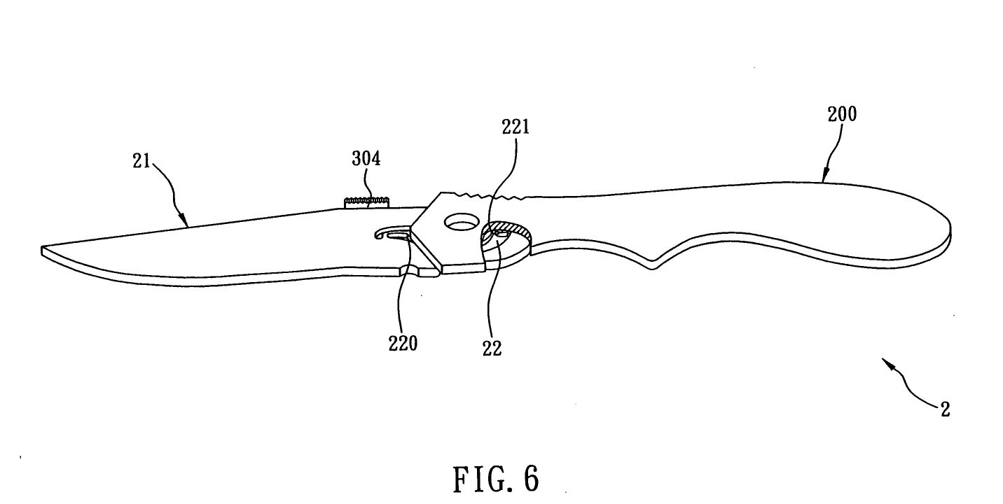

In another preferred embodiment of the present invention, the folding knife 2 as shown in FIGS. 3 and 6 comprises a knife handle 20 and a blade 21, and the knife handle 20 includes a first board 200 and a second board 201 (as shown in FIG. 2), and the boards 200, 201 are stacked and engaged with each other, and a pivotal shaft 204 is disposed at an end of the boards 200, 201, wherein the first board 200 has a protruding pillar 221 disposed at a position proximate to the pivotal shaft 204, and an end of the blade 21 away from its knife tip 210 is pivotally coupled between the first board 200 and the second board 201 through the pivotal shaft 204, and the blade 21 includes a limit slot 22 disposed at a position corresponding to the protruding pillar 221, and the limit slot 22 includes a latch element 220. If the blade 21 is rotated into the knife handle 20, the limit slot 22 will rotate in conformity with the blade 21, until the limit slot 22 and the latch element 220 fix the protruding pillar 221, so that the blade 21 can be fixed and stored into the knife handle 20. If a predetermined force is applied to rotate the blade 21 out of the knife handle 20, the limit slot 22 will rotate in conformity with the blade 21, so that the latch element 220 is pushed by the protruding pillar 221, and the protruding pillar 221 is released to drive the blade 21 to pivot out of the knife handle 20, and thus the folding knife 2 can extend or store its blade 21 flexibly. When the blade 21 is stored in the knife handle 20, the blade 21 is fixed securely and prevented from pivoting out of the knife handle 20 due to vibrations and unintentional collisions, so as to improve the safety of the folding knife 2.

In another preferred embodiment of the present invention, an end of the limit slot 22 as shown in FIGS. 3 and 6 proximate to the pivotal shaft 204 is in an arc shape and provided for the blade 21 to rotate in conformity with the limit slot 22 that is engaged with the protruding pillar 221, and the blade 21 can be rotated within a limit range of the limit slot 22 through the limit slot 22 and the protruding pillar 221, so that the blade 21 can be extended smoothly out of the knife handle 20 at a better angle, or stored smoothly into the knife handle 20. Further, another end of the limit slot 22 is provided for the latch element 220 to fix the protruding pillar 221, or as a space for pushing the protruding pillar 221, so that the folding knife 2 can extend or store its blade 21 flexibly. When the blade 21 is stored in the knife handle 20, the blade 21 is fixed securely and prevented from pivoting out of the knife handle 20 due to vibrations and unintentional collisions, so as to improve the safety of the folding knife 2.

In the aforementioned embodiment, the folding knife 2 as shown in FIGS. 2 and 3 further comprises a resilient member 23 which is a spiral spring, and an end of the resilient member 23 is disposed in the second board 201, and another end of the resilient member 23 is extended to a position of the blade 21 proximate to the pivotal shaft 204. If the blade 21 is stored in the knife handle 20, the resilient member 23 will be twisted. If the blade 21 is rotated out of the knife handle 20, so that the protruding pillar 221 is released by the latch element 220, then the resilient member 23 will produce an action force to pivot the blade 21 out of the knife handle 20. When a user wants to rotate the blade 21 out from the knife handle 20, the user can pivot the blade 21 out of the knife handle 20 through the resilient member 23 for the use of the folding knife 2, so as to greatly improve the convenience of the folding knife 2.

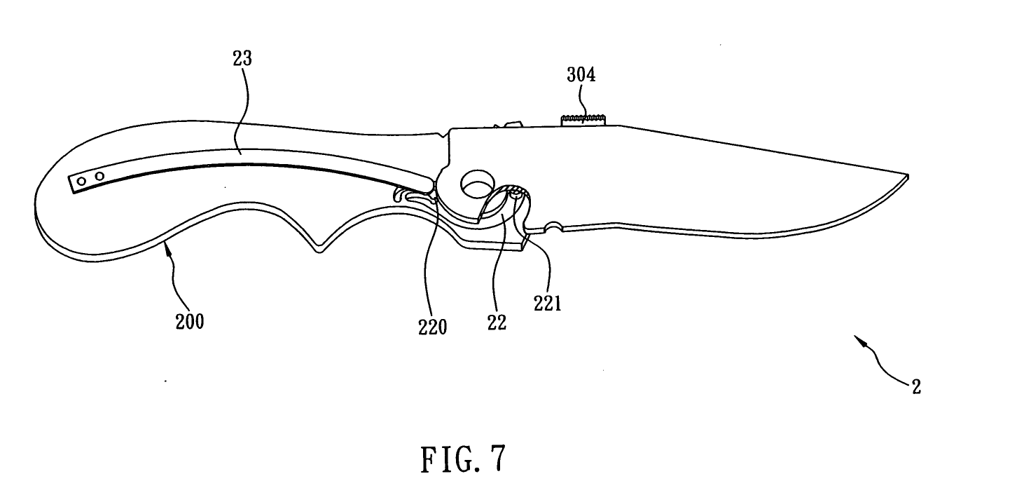

Referring to FIGS. 2 and 3 again, the resilient member 23 is not limited to a spiral spring only, but it can be substituted according to the actual design of the folding knife 2 as shown in FIG. 7. The resilient member 23 of the folding knife 2 can be a resilient stripe, and any arrangement works well as long as the resilient member 23 can rotate the blade 21 out of the knife handle 20. When the protruding pillar 221 is released by the latch element 220, the resilient member 23 produces an action force to pivot the blade 21 out of the knife handle 20.

In the foregoing preferred embodiments as shown in FIGS. 2, 3 and 6, the blade 21 has a pushing portion 213 at the back 212 of the knife. If the blade 21 is stored in the knife handle 20, and the pushing portion 213 is protruded from the knife handle 20, and a user wants to rotate the blade 21 out from the knife handle 20, then the user can hold the folding knife 2 by a hand to rotate the blade 21 out of the knife handle 20 by the pushing portion 213 for the use of the folding knife 2, so as to improve the convenience of the folding knife 2.

In the foregoing preferred embodiments as shown in FIGS. 2, 3 and 6, the second board 201 has a stop plate 304 on a side facing the first board 200, and an end of the stop plate 304 is extended to a position proximate to the blade 21, and an end of the stop plate 304 movably pressed against the blade 21. After the blade 21 is rotated out of the knife handle 20, an end of the blade 21 is stopped precisely at a predetermined position by the stop plate 304 to limit the blade 21 at an appropriate position outside the knife handle 20, so that the blade 21 cannot be rotated freely anymore, and the user can stably use the folding knife 2 for cutting. If it is necessary to store the blade 21 into the knife handle 20 again, an external edge of the stop plate 304 is pressed, such that the stop plate 304 leaves the position of being pressed by the blade 21, and the blade 21 is free to rotate, and then the blade 21 can be stored back into the space of the knife handle 20.

It is noteworthy to point out that the knife handle 20 in accordance with the foregoing preferred embodiments as shown in FIGS. 2, 3 and 6 is comprised of the boards 200, 201, and such arrangement can be changed according to the actual design of the folding knife 2, as long as the blade 21 is pivotally coupled to the knife handle 20. The method and direction of installing the limit slot 22, the latch element 220 and the protruding pillar 221 on the blade 21 or the knife handle 20 can be changed according to the actual design of the folding knife 2 or in compliance with the foregoing preferred embodiments, as long as the knife handle 20 can extend or store its blade 21, and when the blade 21 is stored in the knife handle 20, the blade 21 can be fixed securely.

While the invention has been described by means of specific embodiments, numerous modifications and variations could be made thereto by those skilled in the art without departing from the scope and spirit of the invention set forth in the claims.

What is claimed is:

1. A folding knife, comprising:
a knife handle, having a pivotal shaft installed at an end of the knife handle, a limit slot disposed inside the knife handle and at a position proximate to the pivotal shaft, and a latch element disposed in the limit slot; and
a blade, with an end away from its knife tip being pivotally coupled into the knife handle by the pivotal shaft, and the blade having a protruding pillar disposed at a position corresponding to the limit slot, such that if the blade is rotated towards the knife handle, the protruding pillar will rotate in conformity with the blade in the limit slot, until the protruding pillar is fixed between the limit slot, so that the latch element and the blade is fixed and stored inside the knife handle, and if the blade is rotated out of the knife handle by a predetermined force, the protruding pillar rotates in conformity with the blade and pushes the latch element, so that the protruding pillar is released by the latch element, and the blade can be rotated out of the knife handle.

2. The folding knife as recited in claim 1, further comprising a resilient member, with an end disposed in the knife handle, and another end extended to a position of the blade proximate to the pivotal shaft.

3. The folding knife as recited in claim 2, wherein the resilient member is a spiral spring.

4. The folding knife as recited in claim 2, wherein the resilient member is a resilient stripe.

5. The folding knife as recited in claim 1, wherein the blade includes a pushing portion disposed at a position proximate to the back of the blade and protruded from the knife handle.

6. The folding knife as recited in claim 1, wherein the knife handle includes a stop plate therein, and an end of the stop plate is extended to a position proximate to the blade.

7. A folding knife, comprising:
a knife handle, having a pivotal shaft installed at an end of the knife handle, a protruding pillar disposed inside the knife handle and at a position proximate to the pivotal shaft; and
a blade, with an end away from its knife tip being pivotally coupled into the knife handle by the pivotal shaft, and the blade having a limit slot disposed at a position corresponding to the protruding pillar, such that if the blade is rotated towards the knife handle, the limit slot rotates in conformity with the blade, until the limit slot and the latch element are fixed with the protruding pillar, so that the blade is fixed and stored inside the knife handle, and if the blade is rotated out of the knife handle by a predetermined force, the limit slot rotates in conformity with the blade, and the latch element is pushed by the protruding pillar, and the protruding pillar is released, so that the blade can be rotated out of the knife handle.

8. The folding knife as recited in claim 7, further comprising a resilient member, with an end disposed in the knife handle, and another end extended to a position of the blade proximate to the pivotal shaft.

9. The folding knife as recited in claim 8, wherein the resilient member is a spiral spring.

10. The folding knife as recited in claim 8, wherein the resilient member is a resilient stripe.

11. The folding knife as recited in claim 7, wherein the blade includes a pushing portion disposed at a position proximate to the back of the blade and protruded from the knife handle.

12. The folding knife as recited in claim 7, wherein the knife handle includes a stop plate therein, and an end of the stop plate is extended to a position proximate to the blade.
